(19) United States
(12) Patent Application Publication
(10) Pub. No.: US 2006/0250767 A1
(43) Pub. Date: Nov. 9, 2006

(54) Docking station

(75) Inventors: Timothy James Brophy, Sonoma, CA (US); Donald Earl Angel JR., Foster City, CA (US); Jason Frederick Stone, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Acco Brands USA LLC

(21) Appl. No.: 11/417,947

(22) Filed: May 3, 2006

Related U.S. Application Data
(60) Provisional application No. 60/677,870, filed on May 4, 2005.

(51) Int. Cl. G06F 1/16; G06F 13/00

(52) U.S. Cl. 361/686; 710/303

(57) ABSTRACT

A system for holding a portable computer device is provided. The system includes a platform configured to hold the portable computer device. Also, a port replicator is provided that replicates one or more computer ports of the portable computing device. The port replicator is configured to attach to the platform. In this embodiment, the port replicator may be connected to the portable computing device such that the ports of the port replicator may be used to connect to peripheral devices instead of the ports of the portable computing device. Thus, the ports of the port replicator act as if they were ports of the portable computing device. Additionally, the port replicator is configured to be detached from the platform. The port replicator, in this embodiment, can be used to support the portable computing device when the portable computing device is not being held by the platform. Accordingly, the port replicator may be used as a stand for the portable computing device.

### CROSS-REFERENCE TO RELATED APPLICATIONS

This application is a non-provisional of and claims the benefit of the filing date of U.S. Provisional Application No. 60/677,870, filed on May 4, 2005 which is herein incorporated by reference in its entirety for all purposes.

### BACKGROUND OF THE INVENTION

Embodiments of the present invention generally relate to a portable computing device docking station and more specifically to a dual use port replicator for a portable computing device docking station.

Portable computing devices, such as laptop computers, personal digital assistants (PDAs), cellular telephones, tablet computers, etc., have become more prevalent and preferred by users. Thus, instead of using desktop computers that are typically limited to a single location, such as at a user's office, a portable computing device is used that can be moved from location to location.

A docking station may be used in places where a user typically works and uses the portable computing device, such as at the user's office. The docking station holds the portable computing device in place. One advantage of using the docking station is it may facilitate connecting to other peripherals, such as a full size keyboard, mouse, etc., for the portable computing device. These connections may be made directly from ports of a port replicator built in the computer docking station. When the port replicator is connected to the portable computing device, the ports of the portable computing device are replicated by the port replicator. Thus, peripherals connected to the port replicator are effectively connected to the portable computing device. This is useful in that the connections do not need to be attached and removed from the portable computing device every time the portable computing device is removed and returned to the docking station.

Embodiments of the present invention are directed to improved docking stations, port replicators, and other apparatuses and methods.

### BRIEF SUMMARY OF THE INVENTION

Embodiments of the present invention generally relate to a portable computing device docking station that includes a dual use port replicator.

In one embodiment, a system for holding a portable computer device is provided. The system includes a platform configured to hold the portable computer device. Also, a port replicator is provided that replicates one or more computer ports of the portable computing device. The port replicator is configured to attach to the platform. In this embodiment, the port replicator may be connected to the portable computing device such that the ports of the port replicator may be used to connect to peripheral devices instead of the ports of the portable computing device. Thus, the ports of the port replicator act as if they were ports of the portable computing device. Additionally, the port replicator is configured to be detached from the platform. The port replicator, in this embodiment, can be used to support the portable computing device when the portable computing device is not being held by the platform. Accordingly, the port replicator may be used as a stand for the portable computing device.

In one embodiment, an apparatus for port replication of a portable computing device is provided. The apparatus comprises: a first surface; and a second surface coupled to the first surface, wherein the first surface and the second surface form a wedge shape, wherein the apparatus is configured to attach to a portable computing device holder and is detachable from the portable computing device holder to support the portable computing device.

In another embodiment, a system is provided that comprises: a platform configured to hold a portable computing device; and a port replicator including one or more ports replicating one or more computer ports of the portable computing device, wherein the port replicator is configured to attach to the platform and is configured to detach from the platform such that the port replicator supports the portable computing device when the portable computing device is not being held by the platform.

In yet another embodiment, a system is provided that comprises: a portable computing device including a first set of ports; a computing device holder configured to hold the portable computing device; and a port replicator including a second set of ports, wherein at least a portion of the second set of ports replicate at least a portion of the first set of ports, wherein the port replicator is configured to attach to the computing device holder and configured to support the portable computing device when not attached to the holder.

A further understanding of the nature and the advantages of the inventions disclosed herein may be realized by reference of the remaining portions of the specification and the attached drawings.

### BRIEF DESCRIPTION OF THE DRAWINGS

FIG. 1 depicts a docking station system according to one embodiment of the present invention.

FIGS. 2A and 2B show views of a port replicator being used as a stand according to one embodiment of the present invention.

FIG. 3 shows various views of the system according to embodiments of the present invention.

FIG. 4 depicts connections between a portable computing device and the system according to one embodiment of the present invention.

FIG. 5 shows a one plug connector according to one embodiment of the present invention.

FIG. 6 depicts another embodiment of coupling a portable computing device to the port replicator according to one embodiment of the present invention.

FIG. 7 depicts different adjustment positions of a platform according to a simple fit adjustment system according to one embodiment of the present invention.

FIG. 8 depicts a reference guide for an adjustment system according to one embodiment of the present invention.

### DETAILED DESCRIPTION OF THE INVENTION

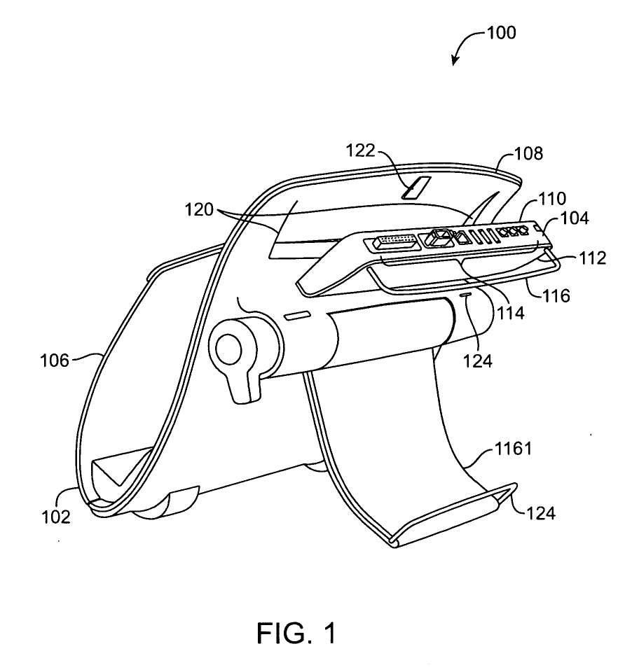

FIG. 1 depicts a docking station system 100 according to one embodiment of the present invention. As shown, system 100 includes a platform 102 and a port replicator 104.

Platform 102 is configured to receive a portable computing device. A portable computing device may be any computing device, such as a laptop computer, personal digital assistant (PDA), pocket personal computer (pc), cellular telephone, tablet pc, etc. The portable computing device is mobile in that it can be easily transported by a user.

Platform 102 may be made of a rigid material, such as a plastic material, metal material, etc. Platform 102, in one embodiment, is formed in a J or U shape. The shape allows the portable computing device to be slid in between a first platform surface 106 and a second platform surface 108. Accordingly, the portable computing device may be sandwiched in between first platform surface 106 and second platform surface 108. The portable computing device may be securely held by platform 102 when it is inserted in between the first platform surface 106 and second platform surface 108.

System 100 also includes a port replicator 104. As shown, port replicator 104 may be formed in a wedge or step shape. A first surface 110 and a second surface 112 form the wedge shape. In one embodiment, first surface 110 is substantially flat and second surface 112 is slightly curved. A middle section is provided in between first surface 110 and second surface 112 to form the wedge shape. Although a wedge shape is shown, it will be recognized that other shapes may be appreciated, such as a trapezoidal shape, oval shape, square shape, etc. As will be discussed below, the shape of port replicator 104 allows a portable computing device that is situated on second surface 112 to be lifted up off a bottom surface when port replicator 104 is being used as a stand.

Port replicator 104 includes one or more ports 114. One or more ports 114 replicate ports that may be included on a portable computing device. In one embodiment, at least a portion of one or more ports included in a portable computing device are included in one or more ports 114.

Ports 114 may include any number of parallel ports, serial ports, Ethernet ports, USB ports, audio 5.1 or stereo option ports, PCI Express slots or ports, or any other ports. In one embodiment, ports 114 may include USB 2.0 ports, EIA-232 DCE DB 9 pin male ports, IEEE 1284 parallel DB25 pin female ports, audio ports, such as 5.1 sound, 3-jack audio ports, Ethernet 10/100-Base-T LAN port RJ45, shielded ports.

Port replicator 104 may include dimensions substantially of 394(L)×305(W)×76.2(H) mm. A person skilled in the art will appreciate other dimensions for port replicator 104.

In one embodiment, port replicator 104 may be coupled to the portable computing device such that ports 114 replicate ports of the portable computing device. Accordingly, ports 114 may be used to couple to peripheral devices as if they were computing device ports. This provides many advantages in that a portable computing device may be inserted into platform 102 and be coupled to port replicator 104. Any connections to ports of port replicator 104 are now usable by the portable computing device. Accordingly, a user does not need to continually connect, disconnect, and reconnect peripheral devices to ports of the computing device ports when the user is using the portable computing device at a location where system 100 is being used. Accordingly, connections to ports at a setup, such as at a user's desk at an office, may remain undisturbed when a user removes the portable computing device from system 100. The user may take the portable computing device to other locations and, when the user returns, the user can connect the portable computing device to the port replicator 104 to use all the peripheral devices that are connected to port replicator 104 in the setup.

In one embodiment, port replicator 104 may power portable computing device 204. For example, ports 114 may include an AC adaptor that is configured to power port replicator 104. Accordingly, a power cable may be connected from port replicator 104 to a power source. When a connector is coupled from a portable computing device to port replicator 104, the portable computing device is thus powered by port replicator 104.

Port replicator 104 also includes a protruding member 116 coupled to second surface 112. Protruding member 116, in one embodiment, may be a rail or wire that forms a substantially rectangular shape. Other shapes may also be contemplated, such as rounded shaped, semi-circular shapes, or any other shapes that protrude from port replicator 104. In one embodiment, protruding member 116 is designed such that it does not block any computer ports of a portable computing device when it is inserted in platform 102 or when port replicator 104 is being used as a stand (as described below).

In one embodiment, protruding member 116 includes an aperture, such as an open middle area. Other shapes of protruding member 116 may also be appreciated, such as multiple holes that are inserted into the middle area. In another embodiment, protruding member 116 may also be a solid member.

Protruding member 116 provides many uses. For example, wires may be inserted through member 116 such that the movement of the wires is restricted. The wires may also be inserted through an end member 124. End member 124 may be shaped similar to protruding member 116. For example, end member 124 may include a hollow metal part that may be used to receive objects, such as wires. Thus, wires may be run through protruding member 116 and end member 124. This helps in organizing and managing wires that may be connected to various peripheral devices from ports 114.

As shown, port replicator 104 can be attached to platform 102. In one embodiment, rails 120 are provided on platform 102 that facilitate the attachment of port replicator 104 to platform 102. In one embodiment, receiving members (e.g., grooves) are provided on port replicator 104 that rails 120 may slide into. When port replicator 104 is slid along railings 120, the receiving members hold port replicator 104 in place. In one embodiment, port replicator 104 is slid along rails 120 until a release tab 102 is released that holds port replicator 104 in place. Port replicator 104 cannot be removed from stand 102 until release tab 122 is depressed such that port replicator 104 can be slid in the reverse direction from which it was attached. Although the above system for attaching port replicator 104 to platform 102 is described, other attachment systems will be appreciated by others skilled in the art.

When attached to stand 102, port replicator 104 is in a convenient position such that a portable computing device may be connected to port replicator easily. Further, port replicator 104 is situated such that one or more ports 114 are easily accessible and can be connected to peripheral devices from platform 102.

In one embodiment, platform 102 includes a stand 1161. As will be discussed in more detail below, stand 1161 may be adjustable such that the angle of platform 102 is adjusted. This may be useful when a portable computing device is inserted into platform 102 and the screen of the portable computing device is open and viewable by the user. Stand 116 may be used to adjust the height of the screen as will be described in more detail below.

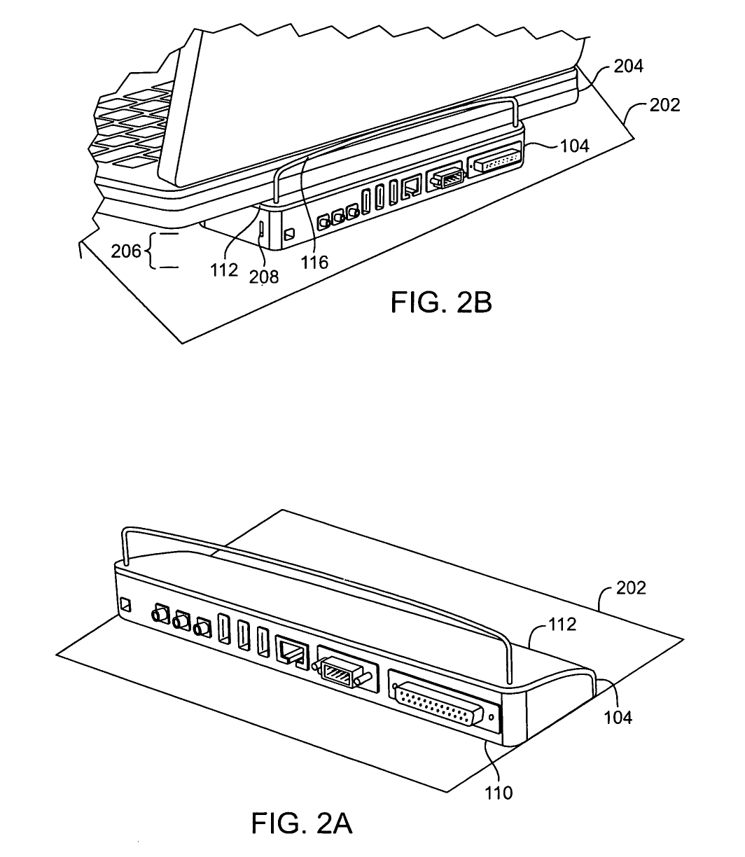

FIG. 2A depicts port replicator 104 being used as a stand according to one embodiment of the present invention. As shown in FIG. 2A, port replicator 104 has been detached from platform 102. Port replicator 104 may then be placed on an object surface 202. For example, object surface 202 may be a desk surface, tabletop, keyboard tray, etc. As shown, first surface 110 of port replicator 104 is placed on object surface 202. When first surface 110 is placed on object surface 202, second surface 112 is raised above object surface 202. In one embodiment, because of the wedge shape of port replicator 104, second surface 112 forms a slight angle with respect to object surface 202.

FIG. 2B shows a portable computing device using port replicator 104 as a stand according to one embodiment of the present invention. As shown, port replicator 104 is placed on object surface 202 and a portable computing device 204 is placed on top of port replicator 104. For example, portable computing device 204 is placed on second surface 112 of port replicator 104. As shown, portable computing device 204 is lifted off of object surface 202. For example, a space 206 between the bottom surface of portable computing device 204 and object surface 202 is formed when portable computing device 204 is placed on top of port replicator 104.

The space provided is very useful. For example, space 206 may allow portable computing device 204 to cool. Thus, portable computing device 204 may operate at a lower temperature because air may circulate under portable computing device 204.

In one embodiment, because of the wedge shape, portable computing device 204 may be rested on second surface 112 of port replicator 104 to form an angle with respect to object surface 202. The angle formed by the wedge shape of port replicator 104 securely supports portable computing device 204 on port replicator 104.

Port replicator may also include surfaces to prevent port replicator 104 from sliding on surface 202 or portable computing device 204 from sliding on second surface 112. For example, one or more rubber pads are provided on front surface 110 of port replicator 104. These pads prevent port replicator 104 from sliding on surface 202. Also, one or more rubber pads may be provided on second surface 112 to prevent portable computing device 204 from sliding off port replicator 104.

Portable computing device 204 is also resistant to sliding off the back of port replicator 104. Protruding member 116 is provided in a position such that the back of portable computing device 204 is supported. Accordingly, protruding member 116 restricts the movement of portable computing device 204 pass the back edge of port replicator 104.

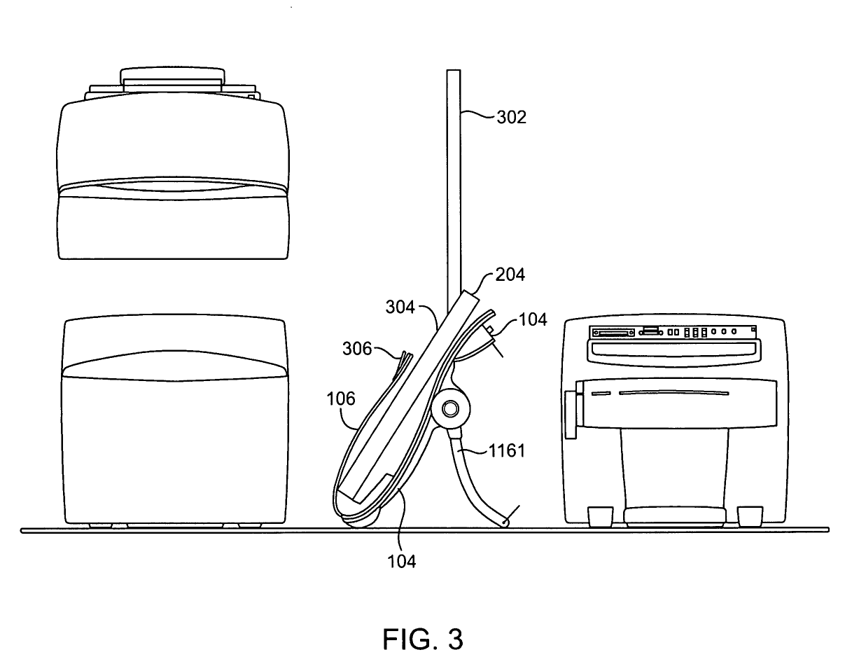

FIG. 3 shows various views of system 100 according to embodiments of the present invention. As shown, the height of platform 104 may be substantially around 227.00 mm and the width may be substantially around 295.00 mm. Although the above measurements are described, it will be understood that different measurements will be appreciated by a person skilled in the art. As shown, platform 104 is adjusted to a position such that the length is 227.00 mm. It will be understood that as stand 116 is adjusted, this length may change to be more or less than 227.0 mm.

As shown, a portable computing device 204 has been inserted into platform 104. In one embodiment, screen 302 of portable computing device 204 has been opened. A base 304 of portable computing device 204 is inserted such that screen 302 is visible to a user. Base 304 typically includes the keyboard, mouse, and body of portable computing device 204. Platform 102 is designed such that when base 304 is inserted into platform 102, keyboard keys are not depressed or any other functions are not actuated by contact with platform 102.

When portable computing device 204 is coupled to port replicator 104, peripheral devices may be used with portable computing device 204. For example, a user may type on a full-size keyboard, use a mouse, etc. When these peripheral devices are used, the user may view the result of the actions on screen 302.

Platform 102 may also include a document holder 306. Document holder 306 is provided on first platform surface 106. Document holder 306 may be a clip or any other attachment device that may hold a document in place. In one embodiment, document holder 306 holds the top of a document allowing it to hang from document holder 306. The user can thus easily view the document while viewing screen 302.

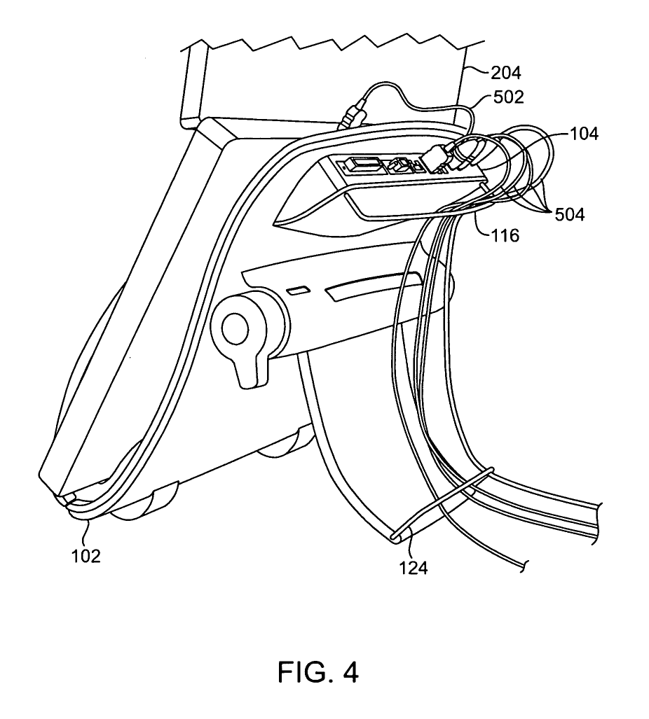

A use of port replicator 104 will now be described according to one embodiment of the present invention. FIG. 4 depicts connections between a portable computing device 302 and system 100 according to one embodiment of the present invention. As shown, portable computing device 204 has been inserted into platform 102. Port replicator 104 has also been attached to platform 102. As shown, a connector 502 is coupled from portable computing device 204 to port replicator 104. Connector 502 is configured to allow one or more ports 114 of port replicator 104 to replicate computing device ports of portable computing device 204.

A number of connectors 504 are coupled to port replicator 104. Connectors 504 are coupled to peripheral devices and allow a user to use the peripheral devices with portable computing device 204. When these peripheral devices are used, such as a keyboard or mouse, the actions are effected on portable computing device 204. For example, when a user types, the typed words may appear on the screen of portable computing device 204.

As shown, connectors 504 are inserted through an aperture in protruding member 116 and end member 124. This restricts the movement of connectors 504 and also manages the positions of them. This provides further organization and manageability of connectors.

Portable computing device 204 can then be removed from platform 102. Also, port replicator 104 can be detached from platform 102. Port replicator 104 can then be placed on object surface 202 and portable computing device 204 may be places on top of port replicator 104. In this case, port replicator 104 is used as a stand. The peripherals connected to port replicator 104 can still be used with portable computing device 204. Also, a user can now use the keyboard or mouse of portable computing device 204 because they are not being obstructed by platform 102 anymore.

Connection Methods Between Portable Computing Device and the Port Replicator

One Plug Connector

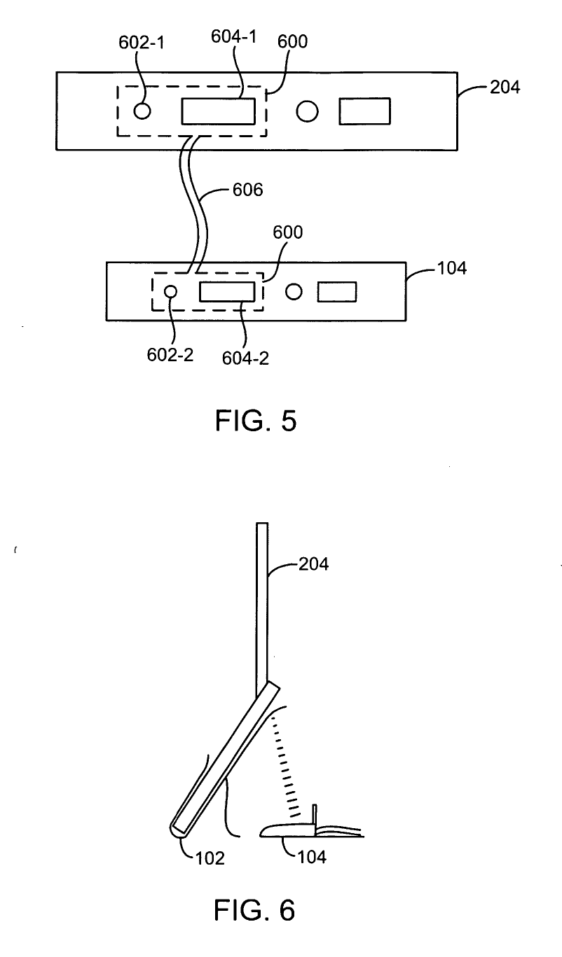

In one embodiment, a plurality of portable computing device ports may be connected to a plurality of ports 114 of port replicator 104. In one embodiment, a single connector may be used to connect the plurality of ports together. FIG. 5 shows a one plug connector 606 according to one embodiment of the present invention. As shown, a one plug connector 606 is provided that includes a single plug 600. Single plug 600 is configured to connect to more than one port. Plug 600 may be any single connection mechanism that can be connected to more than one port. In one embodiment, plug 600 is a housing that includes a connector for each of the ports that it may be connected to.

As shown, plug 600 is configured to connect to a port 602 and a port 604 from each of portable computing device 204 and port replicator 104. Typically, two plugs may be needed to connect port 602-1 to port 602-2 and port 604-1 to port 604-2. For example, port 602-1 may be a power port and port 604 may be a universal communication port, such as a USB port. Typically, a power cord and a USB cord may be needed to separately connect the power ports and USB ports. However, using one plug connector 606, a single connector is used with a single plug 600. In other embodiments, the first port may be a power ports and the second port may be a data port for a local area network (LAN) connection. Other ports include monitor ports, IEEE firewire ports, etc. A single plug can be used to connect to at least two of the different port types.

The diverse port types that can be connected by the one plug connector may be within an area of two square inches or less in some embodiments. This provides for a relatively small area for connections to the single plug connector. Portable computing devices can be made to have diverse ports adjacent to each other. The diverse ports may be female or male ports. The corresponding single plug connector may also be male or female in nature.

One or both ends of a wire sheath may have a single plug for at least two diverse parts. In the side of the sheath, there may be separate electrical conductors for the different ports. In addition, the wire with the plugs may be of any suitable length, and may further be used independently of the docking station in some instances.

The use of the one plug connector eliminates the use of extra electrical wires. This may be advantageous because many wires may be needed to connect between portable computing device 204 and port replicator 104. Thus, the elimination of wires for connectors provides less clutter and is more manageable. Although, one plug connector 606 is shown as connecting to two ports, it will be understood that one plug connector 600 may include a single plug 600 that connects to more than two ports, such as three or more.

Other Connection Methods

FIG. 6 depicts another embodiment of coupling portable computing device 204 to port replicator 104 according to one embodiment of the present invention. As shown, portable computing device 204 can be inserted into platform 102, and port replicator 104 can be detached from platform 102. Port applicator 104 communicates with portable computing device 204 wirelessly. Thus, a wired connection may not be needed in order for port replicator 104 to replicate computing device ports.

In another embodiment, port replicator 104 may also be attached to platform 102 when communicating wirelessly with portable computing device 204. In yet another embodiment, port replicator 104 communicates wirelessly with portable computing device 204 when port replicator 104 is being used as a stand.

Port replicator 104 may communicate through any wireless technologies such as Bluetooth, 802.11a, b, g, infrared, and other wireless technologies. A person of skill in the art will also appreciate other methods of communication between port replicator 104 and portable computing device 204 that can be used.

Adjustment System

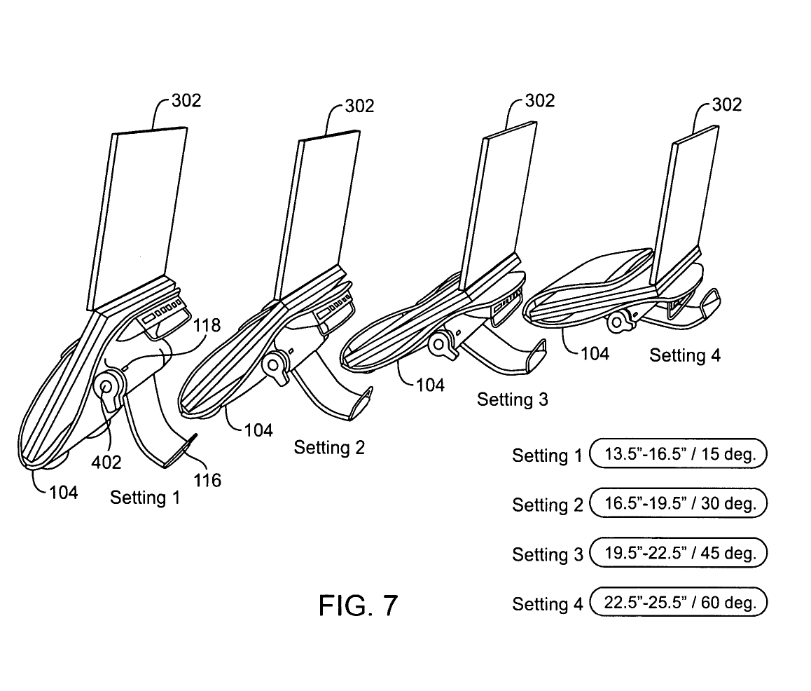

FIG. 7 depicts different adjustment positions of platform 102 according to an adjustment system according to one embodiment of the present invention. In one embodiment, platform 102 includes a plurality of codes, wherein the codes correspond to the dimensions of different users'body parts and optimal ergonomic setups for the users. The plurality of codes form a coding scheme, which may in turn be part of an adjustment guide that may be associated with the adjustable product.

The plurality of codes may also be on a reference guide along with measuring elements for measuring a dimension of a body part. A person can then compare a dimension of a body part such as a hand to a plurality of measuring elements on a reference guide comprising the plurality of codes. The measuring elements may be handprints that are used to measure the size of the hand. After the person determines the optimal measuring element for the body part, the person may then identify a code corresponding to the selected measuring element. Different codes are respectively associated with the different measuring elements. After the person's code is identified, the person can then adjust the adjustable product according to the identified code. Once the platform 102 is adjusted to the person's identified code, the user may optionally use a validation element to verify and/or optimize an optimal ergonomic setup.

Illustratively, a person may obtain a card-shaped reference guide with a yellow handprint, a green handprint, a red handprint, and a blue handprint, wherein each handprint has a different size. The different handprints may be measuring elements, and the different colors associated with the different handprints may be different codes in a coding scheme. The person may determine that his hand size is about the same size as the size of the red handprint in a group of handprints. That person may thereafter identify the color “red” as that person's color for ergonomic adjustment. After the person's color is identified, the person may then adjust platform 102 to a “red” mark in an adjustment guide. The adjustment guide comprises a yellow region, a green region, a red region, and a blue region. Each colored region corresponds to a particular adjustable position or adjustable setting in platform 102. Once this is done, the person's platform 102 is adjusted so that it is ergonomically optimized for that person.

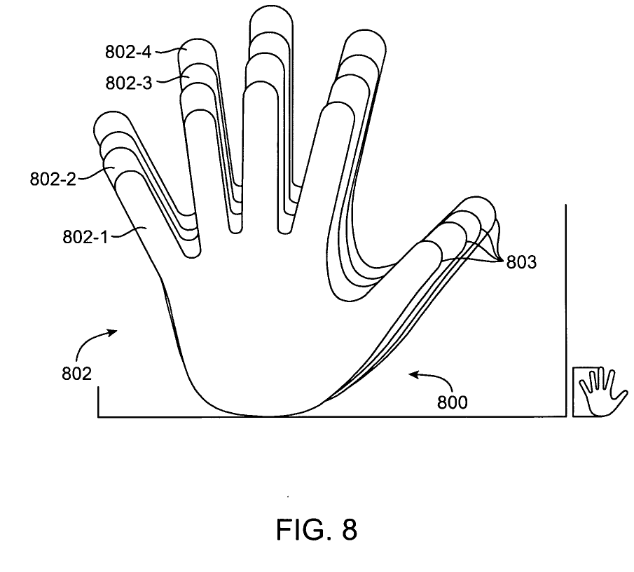

FIG. 8 shows a reference guide 800 comprising plurality of handprints 802 that may be used to determine a code in a plurality of codes. As shown, various handprints 802 are labeled as handprints 802-1, 802-2, 802-3, 802-4. Although four handprints are shown, it will be understood that any number of handprints 802 may be provided.

Each handprint 802-1, 802-2, 802-3, 802-4 is associated with a different code in a coding scheme and has a size that is different than the other handprints. The outline 803 forming each handprint 802-1, 802-2, 802-3, 802-4 may form a measuring element. The handprints 802-1, 802-2, 802-3, 802-4 are associated with different colors. For example, handprints 802-1, 802-2, 802-3, 802-4 may be associated with or are colored green, blue, red, and yellow, respectively. More or less colors and measuring elements may be used in embodiments of the invention.

Each handprint 802 may also correspond to a certain percentage of males or females and may be sized to capture a range of hand sizes. For instance, green handprint 802-1 may have a height suitable for capturing users with hand sizes between about 6.18 inches and 7.39 inches. This may capture the 5th percentile of the females and the 25th percentile of males. Blue handprint 802-2 may have a height suitable for capturing users with hand heights between about 6.76 inches and 7.64 inches. This may capture the 25th percentile of the females and the 50th percentile of males. Red handprint 802-3 may have a height suitable for capturing users with hand heights between about 7.01 inches and 7.91 inches. This may capture the 50th percentile of the females and the 75th percentile of males. Yellow handprint 802-4 may have a height suitable for capturing users with hand heights between about 7.28 inches and 8.35 inches. This may capture the 75th percentile of the females and the 95th percentile of males. Although a single reference guide may be used for both males and females in this embodiment, in other embodiments, two or more reference guides may be used (e.g., one for males and one for females).

As noted above, for most individuals, the size of a user's hand approximates other dimensions of the user's body. For example, a user's hand size may be used to approximate the user's height, arm length, leg length, etc. The use of a user's hand as an ergonomic measuring tool is particularly preferable because a user can simply place his or her hand on the diagram shown in FIG. 8 and can determine his or her code. This allows products, when sold, to include diagrams like the one shown in FIG. 8 and a person can easily determine the code that provides that person with the optimal ergonomic adjustment.

Referring to FIG. 8, in order to determine a code, a user can place his hand on the handprints 802 shown in FIG. 8. The user then determines which handprint 802 most closely fits the user's hand. As shown, handprints 802 are of different sizes. The user may choose a certain handprint 802 if his/her hand substantially fits within one of the handprints.

Once an applicable handprint 802 is determined, the color associated with the handprint 802 is identified by the user. This color is a code in a coding scheme that may be used to adjust platform 102. The color codes may be printed on the platform 102 itself, or may be in the form of stickers on platform 102.

Further details of the adjustment system are disclosed in U.S. patent application Ser. No. 11/122,744, entitled “Apparatus Using a Coding Scheme to Determine Optimal Ergonomic Setup,” filed on May 4, 2005, which is hereby incorporated by reference for all purposes.

Referring to FIG. 7, a window 118 provides guidance in adjusting stand 116 according to the adjustment system. The adjustment system provides a coding (e.g., colors, symbols) system that corresponds to certain ergonomic positions. Depending on the user's dimensions (e.g., a size of a user's hand), a user may associate themselves with a certain code. This code, when adjusted to appear through window 118 indicates an optimal ergonomic position for a user that is associated with that code. The height of screen 302 may be adjusted by adjusting stand 116.

FIG. 7 shows various settings that may be used to adjust stand 116 according to one embodiment of the present invention. As discussed above, an adjustment system may be used to guide the user in adjusting platform 104. In one embodiment, the different settings adjust the position of screen 302. For example the height and distance from a user of screen 302 are adjusted. These positions may correspond to optimal ergonomic positions for various users. For example, four different settings are shown as settings 1-4. These settings may be coded with different codes (e.g., different colors, symbols, etc.). When the user turns a knob 402, these codes appear in window 418. In addition, stand 116 is adjusted as knob 402 is turned. For example, as shown in the key for settings 1, 2, 3, 4, knob 402 may be turned to adjust the angle of stand 116 to different angles. In setting 1, the angle is 15 degrees, in setting 2 the angle is 30 degrees, and the angle is 45 degrees and 60 degrees in settings 3 and 4.

The different settings optimally position screen 302 to a height that should be ergonomically correct for a user associated with that setting. Accordingly, once a user determines a code that is appropriate for him/her, the user can adjust stand 116 such that the code appears in window 118. The position of screen 302 is most likely in the optimal ergonomic position for the user.

Security Slots

Referring back to FIG. 1, platform 102 also includes a security slot 124 according to one embodiment of the present invention. Security slot 124 may be a rectangular slot, with approximately the dimensions of 7 mm by 3 mm. Security slot 124 may be used to secure or lock platform 102 to a stationary object. For example, a locking device may be inserted into the security slot and locked such that the locking device cannot be removed from security slot 124. A cord connected to the locking device may then be secured to or wrapped around a stationary object. This effectively restricts the movement of platform 102. Examples of locks that may be inserted into security slot 124 are described in U.S. Pat. Nos. 6,006,557, 5,502,989, and 6,321,579, which are incorporated by reference in their entirety for all purposes.

Referring back to FIG. 2B, port replicator 104 may also include a security slot 208 in one embodiment. Security slot 208 may be used the same way as described with respect to security slot 124. Because port replicator 104 can be detached from stand 102, it may be desirable to lock it to a stationary object. Also, in one embodiment, port replicator 104 may be locked with a locking device when it is attached to platform 102. This may prevent a user from detaching port replicator 104. Also, it will be recognized that other methods of locking port replicator 104 to stand 102 will be appreciated. For example, release tab 122 may be locked after port replicator 104 is slid along rails 120 such that it cannot be depressed to release port replicator 104.

Accordingly, a port replicator 104 is provided that may be attached to platform 102 and also detached from platform 102. Port replicator 104 may be used as a stand for portable computing device 204 when it is detached.

Embodiments of the present invention include many advantages. For example, port replicator 104 includes multiple uses. For example, port replicator 104 may be attached to platform 102 and provide port replication in a convenient position when a computing device 204 is inserted in platform 102. Further, port replicator 104 may be detached from platform 102 and may be used as a stand for computing device 204. This provides a dual use for port replicator 104. When it used as a stand, computing device 204 may be cooled off as it is lifted off of an object surface by port replicator 104.

All of the above patents, patent applications, and publications are herein incorporated by reference in their entirety for all purposes as if present in this application. None is admitted to be prior art to the present application.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. An apparatus for port replication of a portable computing device, the apparatus comprising:
a first surface; and
a second surface coupled to the first surface, wherein the first surface and the second surface form a wedge shape,
wherein the apparatus is configured to attach to a portable computing device holder and is detachable from the portable computing device holder to support the portable computing device.

2. The apparatus of claim 1, further comprising a protruding member coupled to the first surface or second surface.

3. The apparatus of claim 2, wherein the protruding member is configured to rest on a back of the portable computing device when the apparatus is supporting the portable computing device.

4. The apparatus of claim 2, wherein the protruding member is configured to restrict movement of one or more wires from the apparatus.

5. The apparatus of claim 2, wherein the protruding member is configured to receive one or more wires from the apparatus through an aperture.

6. The apparatus of claim 1, further comprising one or more ports, the one or more ports replicating one or more computer ports of the portable computing device.

7. The apparatus of claim 1, further comprising a security slot configured to receive a lock.

8. A system comprising:
a platform configured to hold a portable computing device; and
a port replicator including one or more ports replicating one or more computer ports of the portable computing device, wherein the port replicator is configured to attach to the platform and is configured to detach from the platform such that the port replicator supports the portable computing device when the portable computing device is not being held by the platform.

9. The system of claim 8, wherein the platform comprises a stand.

10. The system of claim 9, wherein the stand is adjustable.

11. The system of claim 10, wherein the platform comprises an adjustment system that is used to adjust the stand to an optimal ergonomic position for a user.

12. The system of claim 11, wherein the platform comprises a window, the window showing different symbols corresponding to different ergonomic positions of the adjustment system.

13. The system of claim 9, further comprising a document holder.

14. The system of claim 8, wherein the port replicator and portable computing device communicate with each other wirelessly.

15. The system of claim 8, wherein the portable computing device comprises a first port and a second port and the port replicator comprises a third port and a fourth port, the system further comprising:
a single connector configured to connect the first port and second port to the third port and fourth port.

16. The system of claim 8, wherein the portable computing device holder or port replicator comprise a security slot that allows a locking device to be inserted in the security slot to secure the portable computing device or port replicator.

17. A system comprising:
a portable computing device including a first set of ports;
a computing device holder configured to hold the portable computing device; and
a port replicator including a second set of ports, wherein at least a portion of the second set of ports replicate at least a portion of the first set of ports,
wherein the port replicator is configured to attach to the computing device holder and configured to support the portable computing device when not attached to the holder.

18. The system of claim 17, wherein the port replicator and portable computing device communicate with each other wirelessly.

19. The system of claim 17, wherein the portable computing device comprises a first port and a second port and the port replicator comprises a third port and a fourth port, the system further comprising:
a single connector configured to connect the first port and second port to the third port and fourth port.

20. The system of claim 17, wherein the computing device holder or port replicator comprise a security slot that allows a locking device to be inserted in the security slot to secure the portable computing device or port replicator.

21. A single connector adapted to connect to first and second ports of a computer at the same time and also adapted to connect to third and fourth ports of an electrical apparatus at the same time.
